(19) United States
(12) Patent Application Publication
(10) Pub. No.: US 2006/0024571 A1
(43) Pub. Date: Feb. 2, 2006

(54) Cylindrical lithium rechargeable battery and method for fabricating the same

(76) Inventors: Jong Ku Kim, Cheonan-si (KR); Akihiko Saito, Cheonan-si (KR)

Correspondence Address: McGuireWoods LLP, Suite 1800, 1750 Tysons Boulevard, McLean, VA, 22102, US

(21) Appl. No.: 11/165,321

(22) Filed: Jun. 24, 2005

(30) Foreign Application Priority Data
Jun. 25, 2004 (KR) 10-2004-0048304

(51) Int. Cl. H01M 2/26; H01M 2/02; H01M 2/08; H01M 10/04; H01M 2/06

(52) U.S. Cl. 429/161; 429/181; 429/174; 29/623.2; 29/623.4

(57) ABSTRACT

A cylindrical lithium rechargeable battery has an anode tab that is welded to a lower surface of a cylindrical case through laser welding. The cylindrical lithium rechargeable battery includes a cylindrical electrode assembly formed at a center portion thereof with a space section and including a cathode plate, an anode plate, a separator interposed between the cathode plate and the anode plate, a cathode tab that is coupled with an end of the cathode plate, and an anode tab that is coupled with an end of the anode plate. The battery also comprises a cylindrical case including a cylindrical sidewall that forms a space to receive the cylindrical electrode assembly therein and a lower wall that is provided at a bottom of the cylindrical sidewall and a cap assembly that is coupled with an upper portion of the cylindrical case and has a terminal section that is coupled with the cylindrical electrode assembly. In addition, a center pin is installed in the space section of the cylindrical electrode assembly, wherein the anode tab is coupled with an inner center portion of the lower wall of the cylindrical case by laser welding.

### CROSS REFERENCE TO RELATED APPLICATION

This application claims priority to and the benefit of Korean Patent Application No. 2004-0048304 filed on Jun. 25, 2004, which is hereby incorporated by reference for all purposes as if fully set forth herein.

### BACKGROUND OF THE INVENTION

1. Field of the Invention

The present invention relates to a cylindrical lithium secondary battery and a method of fabricating the same. In particular, the present invention relates to a cylindrical lithium secondary battery and a method of fabricating the same, in which an anode tab is welded to a lower surface of a cylindrical case by laser welding.

2. Description of the Prior Art

Recently, various portable lightweight and compact electronic devices such as cellular phones, notebook computers, and camcorders have been actively developed and produced. These devices are equipped with a battery pack that may include at least one rechargeable battery that is capable of outputting a predetermined voltage to drive the portable electronic device for a predetermined period of time.

Possible rechargeable batteries include a nickel-cadmium (Ni—Cd) battery, a nickel-metal hydride (Ni—MH) battery, and a lithium rechargeable battery such as a lithium battery and a lithium-ion battery.

A lithium rechargeable battery may have a driving voltage of 3.6 V or more, which is three times higher than the voltage of the Ni—Cd or the Ni—MH batteries that are currently used as a power source for a portable electronic device. Further, the lithium rechargeable battery has a relatively high energy density per unit mass, so it has a variety of applications.

Lithium rechargeable batteries may use lithium-based oxides as cathode active materials and carbonaceous materials as anode active materials. Generally, lithium rechargeable batteries may have liquid electrolytes or polymer electrolytes. Batteries that use a liquid electrolyte are referred to as lithium ion batteries and batteries that use a polymer electrolyte are referred to as lithium polymer batteries. In addition, lithium rechargeable batteries may have a cylindrical, rectangular box or a pouch type shape depending on their external appearances.

Cylindrical lithium rechargeable batteries typically include an electrode assembly with a cathode plate coated with cathode active materials, an anode plate coated with anode active materials, and a separator interposed between the cathode plate and the anode plate. The separator prevents a short-circuit between the cathode plate and anode plate and allows the flow of lithium ions through it. The battery further comprises a cylindrical case to house the electrode assembly and an electrolyte that is injected into the cylindrical case to allow the lithium ions to flow.

The cathode plate that is coated with cathode active materials is coupled with a cathode tab and is stacked on the anode plate that is coated with anode active materials and is coupled with an anode tab. The separator is then interposed between the cathode plate and the anode plate. The cathode plate, the anode plate, and the separator are wound, thereby forming the electrode assembly.

The electrode assembly is then accommodated into a cylindrical case and the electrolyte is injected into the case. Then, the cylindrical case is sealed, thereby forming the cylindrical lithium rechargeable battery.

When the electrode assembly is accommodated in the cylindrical case, a cathode tab or an anode tab is fixed to a lower end of the cylindrical case through resistance welding. In resistance welding, a large amount of current is applied to a base metal to melt it from the heat that is derived from contact resistance of a joint section and the mechanical pressure that is applied to the melted base metal to weld an object, such as an electrode tab.

If a cathode tab is coupled with the lower end of the cylindrical case by resistance welding, the electrodes must be exchanged frequently which increases the manufacturing time for rechargeable batteries and may increase when producing a large amount of rechargeable batteries. In addition, in resistance welding, welding energy is gradually transferred from a welding surface to a peripheral portion of an object to be welded such that the welding bond may have uneven welding strength. Furthermore, impurities may result or a spark may occur during the resistance welding process which may cause damage to the electrode assembly.

### SUMMARY OF THE INVENTION

The present invention provides a cylindrical lithium rechargeable battery in which an anode tab is welded to a lower surface of a cylindrical case through a laser welding process.

The present invention also provides a method of fabricating the same.

Additional features of the invention will be set forth in the description which follows, and in part will be apparent from the description, or may be learned by practice of the invention.

The present invention discloses a cylindrical lithium rechargeable battery comprising a cylindrical electrode assembly including a cathode plate, an anode plate, and a separator that is interposed between the cathode plate and the anode plate. The battery further comprises a cathode tab that is attached to an end of the cathode plate and an anode tab that is attached to an end of the anode plate. A cylindrical case including a cylindrical sidewall that forms a predetermined space that receives the cylindrical electrode assembly therein and a lower wall is provided at a bottom of the cylindrical sidewall to seal the bottom of the cylindrical sidewall. A cap assembly is coupled with an upper portion of the cylindrical case to cover it and has a terminal section that is coupled with the cylindrical electrode assembly. In addition, the battery comprises a center pin that is installed in the space section of the cylindrical electrode assembly. The anode tab is coupled with an inner center portion of the lower wall of the cylindrical case through by laser welding.

The present invention further discloses a method for fabricating a cylindrical lithium rechargeable battery comprising preparing a cylindrical electrode assembly including a cathode plate, an anode plate, a separator interposed between the cathode plate and the anode plate, a cathode tab coupled with the cathode plate, and an anode tab coupled with the anode plate. The cylindrical electrode assembly is housed in a cylindrical case and a center pin is inserted into the predetermined space section of the cylindrical electrode assembly. The cathode tab or the anode tab is coupled with a lower surface of the cylindrical case through a laser welding process while applying pressure to the cathode tab or the anode tab using the center pin.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1a is a perspective view of a cylindrical lithium rechargeable battery according to an exemplary embodiment of the present invention.

FIG. 1b is a sectional view taken along line “1a-1a” shown in FIG. 1a.

FIG. 2 is a schematic of a method of fabricating a cylindrical lithium rechargeable battery according to an exemplary embodiment of the present invention.

FIG. 3a, 3b, 3c, 3d, 3e, 3f, and 3g illustrate a center pin used for fabricating a cylindrical lithium rechargeable battery according to an exemplary embodiment of the present invention.

### DETAILED DESCRIPTION OF THE PREFERRED EMBODIMENTS

The present invention discloses a cylindrical lithium rechargeable battery and a method of fabricating the same. In this battery, an anode tab of an electrode assembly is coupled with a cylindrical case by laser welding instead of resistance welding, thereby reducing the amount of impurities and preventing the electrode assembly from being damaged from sparks which may be generated during the resistance welding process. In addition, this provides uniform welding strength between the anode tab and the cylindrical case.

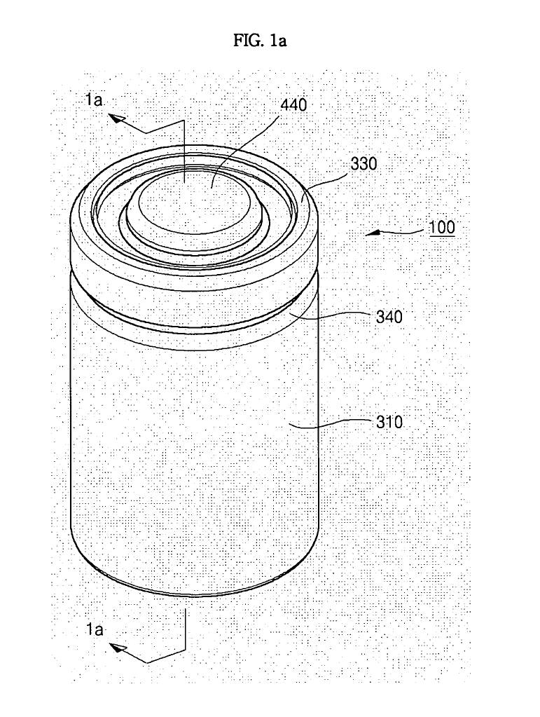

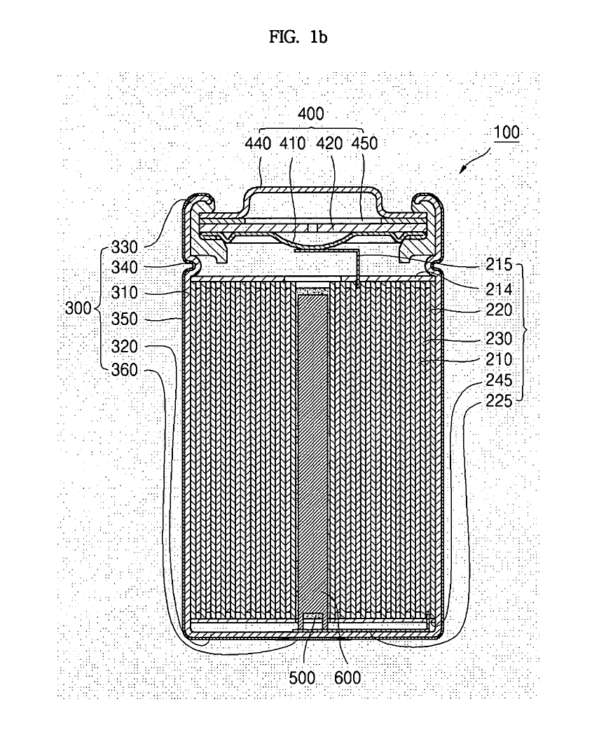

FIG. 1a is a perspective view of a cylindrical lithium rechargeable battery 100 according to an exemplary embodiment of the present invention, and FIG. 1b is a sectional view taken along line “1a-1a” shown in FIG. 1a.

As shown in FIG. 1a and FIG. 1b, the cylindrical lithium rechargeable battery 100 includes an electrode assembly 200 that generates a voltage during charging and discharging, a cylindrical case 300 for receiving the electrode assembly 200 therein, and a cap assembly 400 that is coupled with an upper portion of the cylindrical case 300 to prevent the electrode assembly 200 from being separated from the cylindrical case 300. The battery further comprises an electrolyte 500 that is injected into the cylindrical case 300 to allow lithium ions to flow within the cylindrical case 300 through the electrode assembly 200 and a center pin 600 that applies pressure to an electrode tab of the electrode assembly 200 such that the electrode tab makes contact with the cylindrical case 300 when the electrode tab is welded to a lower end of the cylindrical case 300. The center pin 600 also prevents the wound electrode assembly 200 from being unwound.

The electrode assembly 200 includes a cathode plate 210 coated with cathode active materials, an anode plate 220 coated with anode active materials, and a separator 230 interposed between the cathode plate 210 and the anode plate 220 to prevent a short-circuit between the cathode plate 210 and the anode plate 220 while allowing only lithium ions to flow. In addition, the cathode plate 210, the anode plate 220, and the separator 230 are wound as a substantially cylindrical structure and accommodated in a cylindrical case 300. In general, a cathode tab 215 comprising aluminum for example, is bonded to the cathode plate 210 such that the cathode tab 215 may protrude upwards from an upper portion of the cathode plate 210. An anode tab 225 comprising nickel for example, is bonded to the anode plate 220 such that the anode tab 225 may protrude downwards from a lower portion of the anode plate 220. In addition, an upper insulating plate 214 and a lower insulating plate 245 are coupled with upper and lower portions of the electrode assembly 200, to insulate the electrode assembly 200 from the cap assembly 400 or the cylindrical case 300.

The cylindrical case 300 includes a cylindrical sidewall 310 with an inner cavity section with a predetermined diameter to receive the electrode assembly 200 therein and a lower wall 320 formed at a lower portion of the cylindrical sidewall 310 to seal the lower portion of the cylindrical sidewall 310. An upper portion of the cylindrical sidewall 310 may be opened to receive the electrode assembly 200 therein. In addition, the anode tab 225 of the electrode assembly 200 is coupled with the center of the lower wall 320 of the cylindrical case 300 so that the cylindrical case 300 acts as an anode. A crimped section 330, which is bent in a predetermined direction, is formed at the upper portion of the cylindrical case 300 to press the cap assembly 400. A beaded section 340, which protrudes inwardly from the cap assembly 400, is provided below the crimped section 330 to press the cap assembly 400.

In general, the cylindrical case 300 may comprise Al, Fe, Al—Fe alloys, or equivalents thereof, for example. A first anti-corrosion layer 350 is formed at an outer wall of the cylindrical case 300 to prevent corrosion of the cylindrical case 300. The first anti-corrosion layer 350 is a coating comprising a corrosion-resistant material such as nickel (Ni), for example, but the present invention is not limited thereto.

In addition, since the first anti-corrosion layer 350 that is formed at the center of an outer portion of the lower wall 320 of the cylindrical case 300 may be removed when the electrode tab is welded to the lower end of the cylindrical case 300, a second anti-corrosion layer 360 is formed at the center of the outer portion of the lower wall 320 of the cylindrical case 300 to prevent corrosion of the lower wall 320 of the cylindrical case 300. The second anti-corrosion layer 360 preferably includes a rust inhibitor.

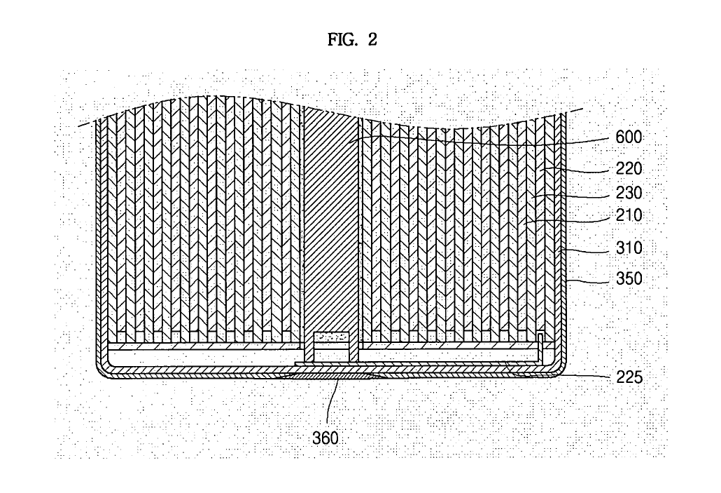

The cap assembly 400 includes a conductive safety vent 410 that may deform when an overcharge occurs or heat is abnormally generated and to which the cathode tab 215 is welded. The cap assembly 400 also includes a printed circuit board (PCB) 420 that is coupled with an upper portion of the conductive safety vent 410 so that the PCB's 420 circuits shut-off when the conductive safety vent 410 is deformed. In addition, a positive thermal coefficient (PTC) 430 may be coupled with an upper portion of the PCB 420 (as shown in FIG. 2) so that the PTC's 430 circuits shut-off when the temperature exceeds a predetermined level. A conductive cathode cap 440 is coupled with an upper portion of the PTC 430 to apply current to the exterior. An insulating gasket 450 that surrounds lateral portions of the conductive safety vent 410, the PCB 420, the PTC 430, and the conductive cathode cap 440 to insulate the elements from the cylindrical case 300.

The electrolyte 500 acts as a medium for lithium ions that are generated during electrochemical reactions at the anode and the cathode of the rechargeable battery during the charging and discharging. The electrolyte 500 comprises a non-aqueous organic electrolyte solution such as a mixture of lithium salt and a high-purity organic solvent, for example. In addition, the electrolyte 500 may comprise a polymer. However, the present invention does not limit the contents of the electrolyte 500.

The center pin 600 is inserted into a central space of the wound electrode assembly 200. When the anode tab 225 of the electrode assembly 200 is welded to the center of the lower wall 320 of the cylindrical case 300, the center pin 600 applies pressure to the anode tab 225 to make it contact the lower wall 320 of the cylindrical case 300. In addition, the center pin 600 may prevent the wound electrode assembly 200 from being unwound.

FIG. 2 explains a method for fabricating the cylindrical lithium rechargeable battery of an exemplary embodiment of the present invention. In particular, FIG. 2 shows a process for coupling the anode tab of the electrode assembly to the lower wall of the cylindrical case.

Referring to FIG. 2, the cylindrical electrode assembly 200 that is formed at an inner central portion of the case 300 with a predetermined space portion and includes the cathode plate 210 that has a cathode current collector that is coated with cathode active materials, the anode plate 220 that has an anode current collector that is coated with anode active materials, the separator 230 interposed between the cathode plate 210 and the anode plate 220, the cathode tab 215 that is coupled with an end of the cathode plate 210, and the anode tab 225 that is coupled with an end of the anode plate 220.

After accommodating the wound electrode assembly 200 in the cylindrical case 300, the center pin 600 is inserted into the electrode assembly 200 through the space portion of the electrode assembly 200. Then, pressure is applied to the center pin 600 so that either the cathode tab 215 or the anode tab 225, for example, the native electrode tab 225, makes contact with the inner center portion of the lower wall 320 of the cylindrical case 300.

To prevent the center pin 600 from becoming bonded to the anode tab 225 due to heat that is generated during laser welding only an outer peripheral portion of the lower surface of the center pin 600 makes contact with the anode tab 225.

After allowing the anode tab 225 to contact the inner center portion of the lower wall 320 of the cylindrical case 300 with the center pin 600, a laser welding process is carried out by irradiating a laser beam on to an outer center portion of the lower wall 320 of the cylindrical case 300, thereby coupling the anode tab 225 to the lower wall 320 of the cylindrical case 300.

In contrast with resistance welding in which heat is gradually transferred from a welding surface of an object to a peripheral portion of the object, laser welding is a high-speed welding technique in which heat is directly transferred in a thickness direction of the object. Thus, laser welding minimizes thermal deformation of the object. In addition, since laser welding is rarely affected by the welding environment, it may allow a high volume production. Furthermore, since laser welding does not generate a spark as resistance welding does, the electrode assembly can be protected from damage.

In addition, while the laser beam is being irradiated onto the outer center portion of the lower wall 320 of the cylindrical case 300, the first anti-corrosion layer 350 that is formed at the outer center portion of the lower wall 320 of the cylindrical case 300 is removed due to high energy of the laser beam.

After coupling the anode tab 225 to the inner center portion of the lower wall 320 of the cylindrical case 300, the second anti-corrosion layer 360 is coated on the outer center portion of the lower wall 320 of the cylindrical case 300. This layer prevents the portions of the outer center portion of the lower wall 320 of the cylindrical case 300 in which the anti-corrosion layer 350 has been removed due to the later welding from being corroded.

Then, a typical manufacturing process for fabricating a cylindrical lithium rechargeable battery 100 is performed.

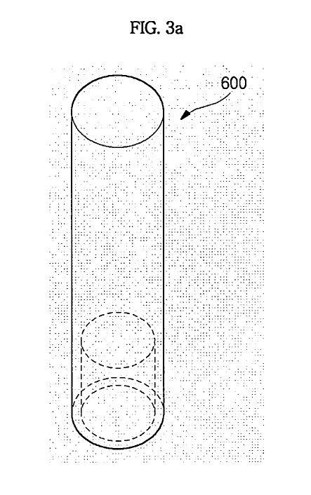

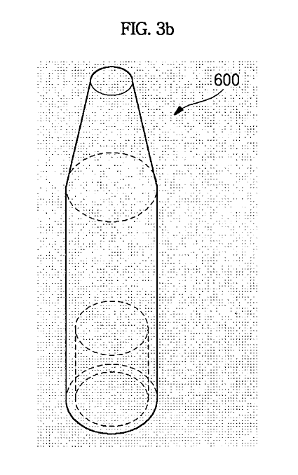

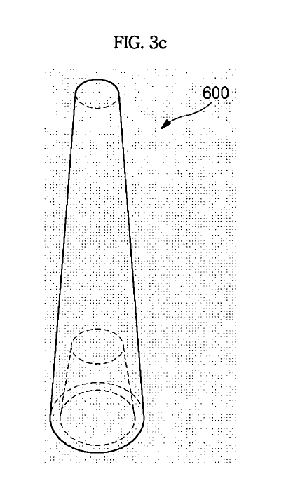

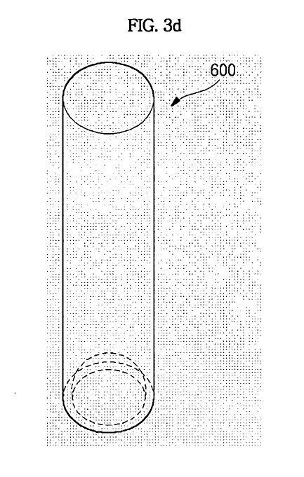

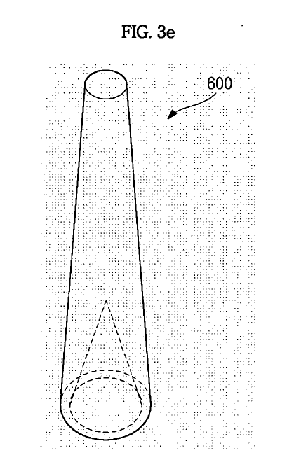

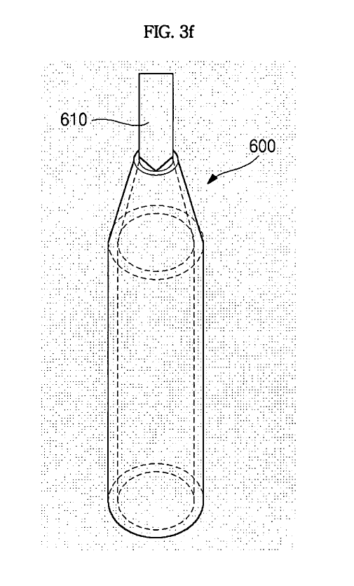

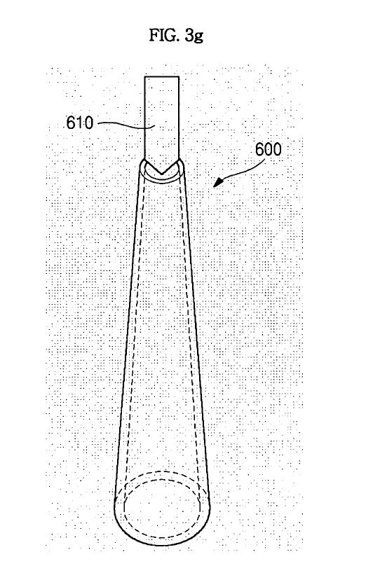

FIG. 3a, FIG. 3b, FIG. 3c, FIG. 3d, FIG. 3e, and FIG. 3f illustrate the center pin 600 that is used to fabricate the cylindrical lithium rechargeable battery according to an exemplary embodiment of the present invention.

Referring to FIG. 3a, FIG. 3b, FIG. 3c, FIG. 3d, FIG. 3e, and 3f, only the outer peripheral portion of the lower surface of the center pin 600 makes contact with the anode tab 225 to prevent the center pin 600 from being coupled with the anode tab 225 due to the heat that is generated during the laser welding process.

For example, the center pin 600 may be formed as a body of revolution of various shapes such as cylindrical, truncated conical, and cylindrical formed at an upper portion thereof with a truncated conical shape.

In addition, as shown in FIG. 3a, FIG. 3b, FIG. 3c, and FIG. 3d, the lower center portion of the center pin 600 may be recessed in various shapes, such as cylindrical, truncated conical, conical, and spherical, such that only the outer peripheral portion of the center pin 600 can make contact with the anode tab 225.

As shown in FIG. 3e and FIG. 3f, upper and lower portions of the center pin 600 may be open. Thus, when the anode tab 225 is coupled with the inner portion of the lower wall 320 of the cylindrical case 300 through laser welding, pressure is applied to the anode tab 225 using a separate pusher 610 to allow the anode tab 225 to make contact with the inner portion of the lower wall 320 of the cylindrical case 300.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A cylindrical lithium rechargeable battery, comprising:
a cylindrical electrode assembly that is formed at a center portion thereof with a space section and including a cathode plate, an anode plate, a separator interposed between the cathode plate and the anode plate, a cathode tab that is coupled with an end of the cathode plate, and an anode tab that is coupled with an end of the anode plate;
a cylindrical case including a cylindrical sidewall that forms a space to receive the cylindrical electrode assembly therein and a lower wall that is provided at a bottom of the cylindrical sidewall;
a cap assembly that is coupled with an upper portion of the cylindrical case such that an upper portion of the cylindrical case is covered by the cap assembly and has a terminal section that is coupled with the cylindrical electrode assembly; and
a center pin that is installed in the space section of the cylindrical electrode assembly, wherein the cathode tab or the anode tab is coupled with an inner center portion of the lower wall of the cylindrical case by a laser welding.

2. The cylindrical lithium rechargeable battery of claim 1,
wherein the center pin is aligned so that only an outer peripheral portion of a lower wall of the center pin contacts the cathode tab or the anode tab.

3. The cylindrical lithium rechargeable battery of claim 2,
wherein the center pin has a body of revolution shape.

4. The cylindrical lithium rechargeable battery of claim 2,
wherein the center pin is formed at a center of a lower surface thereof with a recess.

5. The cylindrical lithium rechargeable battery of claim 4,
wherein the recess has a body of revolution shape.

6. The cylindrical lithium rechargeable battery of claim 3,
wherein the center pin has a body of revolution shape; and
wherein the center pin comprises a hole that connects an upper and lower part of the center pin.

7. The cylindrical lithium rechargeable battery of claim 1, further comprising a first anti-corrosion layer that is formed at an outer portion of the cylindrical case.

8. The cylindrical lithium rechargeable battery of claim 7,
wherein the first anti-corrosion layer comprises nickel.

9. The cylindrical lithium rechargeable battery of claim 1, further comprising a second anti-corrosion layer that is formed at an outer center portion of the lower wall of the cylindrical case.

10. The cylindrical lithium rechargeable battery of claim 9,
wherein the second anti-corrosion layer comprises a rust inhibitor.

11. A method for fabricating a cylindrical lithium rechargeable battery, comprising:
preparing a cylindrical electrode assembly formed at a center portion thereof with a space section and including a cathode plate, an anode plate, a separator interposed between the cathode plate and the anode plate, a cathode tab that is coupled with an end of the cathode plate, and an anode tab that is coupled with an end of the anode plate;
accommodating the cylindrical electrode assembly in a cylindrical case;
inserting a center pin into the space section of the cylindrical electrode assembly; and
coupling the cathode tab or the anode tab to a lower surface of the cylindrical case through laser welding.

12. The method of claim 11, further comprising allowing one of the cathode tab and the anode tab to contact the lower surface of the cylindrical case by applying pressure to the cathode tab or the anode tab with the center pin, after accommodating the cylindrical electrode assembly in the cylindrical case.

13. The method of claim 12,
wherein the center pin is aligned so that only an outer peripheral portion of a lower surface of the center pin makes contact with the cathode tab or anode tab.

14. The method of claim 11, further comprising forming an anti-corrosion layer at an outer center portion of the lower surface of the cylindrical case.

15. The method of claim 11, wherein the coupling is done while applying pressure to the cathode tab or the anode tab using the center pin.
